(19) United States
(12) Patent Application Publication
(10) Pub. No.: US 2025/0033583 A1
(43) Pub. Date: Jan. 30, 2025

(54) MOTOR VEHICLE WITH AN ELECTRICAL CONNECTION ON THE INSIDE FOR AN ELECTROMECHANICAL WHEEL BRAKE

(71) Applicant: Continental Automotive Technologies GmbH, Hannover (DE)

(72) Inventor: Stefan Drumm, Saulheim (DE)

(73) Assignee: Continental Automotive Technologies GmbH, Hannover (DE)

(21) Appl. No.: 18/715,702

(22) PCT Filed: Oct. 17, 2022
(86) PCT No.: PCT/DE2022/200238

§ 371 Date: Jun. 1, 2024

(30) Foreign Application Priority Data
Dec. 3, 2021 (DE) 10 2021 213 787.3

(51) Int. Cl. B60R 16/023; B60T 13/74

(52) U.S. Cl. CPC B60R 16/023; B60T 13/741

(57) ABSTRACT

A motor vehicle comprises a chassis and a body portion, which delimits a wheelhouse region from a body inner region. A wheel with an associated electromechanical wheel brake is arranged on the part of the wheelhouse region. The electromechanical wheel brake is connectable via an electrical line to an electronic open-loop and closed-loop control unit of the motor vehicle, wherein the electrical line comprises a first line portion in the wheelhouse region and a second line portion in the body inner region. The first and the second line portions are connected to each other via an electrical connecting device, which is arranged in the body inner region.

The present application is a National Stage Application under 35 U.S.C. § 371 of International Patent Application No. PCT/DE2022/200238 filed on Oct. 17, 2022, and claims priority from German Patent Application No 10 2021 213 787.3 Filed on Dec. 3, 2021, in the German Patent and Trademark Office, the disclosures of which are herein incorporated by reference in their entireties.

### TECHNICAL FIELD

The embodiments relate to a motor vehicle with a body portion and an electromechanical wheel brake.

### BACKGROUND

Hydraulic wheel brakes are connected on the body side via a rigid brake line and on the wheelhouse side via a flexible brake hose. The coupling point between these two portions is a hydraulic screw connection which, because of its robust nature, can be arranged in the wheelhouse or even on the underbody of the vehicle. It is exposed there to adverse environmental conditions, such as dirt, wet, ice and stone chips. During a technical vehicle inspection, hairline cracks may be found in the surface of the brake hoses. The brake hoses must then be replaced. It is assumed that appropriate regulations for replacing defective lines are provided for electrical lines to the brake actuators of novel wheel brakes.

### SUMMARY

It is the object to provide an electrical connection of an electromechanical wheel brake to an electronic open-loop and closed-loop control unit of a motor vehicle, which is reliably protected from environmental and ambient influences.

A motor vehicle is provided comprising a chassis and a body portion, which delimits a wheelhouse region from a body inner region, wherein a wheel with an associated electromechanical wheel brake is arranged on the part of the wheelhouse region, wherein the electromechanical wheel brake is connectable via an electrical line to an electronic open-loop and closed-loop control unit of the motor vehicle. The electrical line comprises a first line portion in the wheelhouse region and a second line portion in the body inner region, the first and the second line portions being connected to each other via an electrical connecting device, which is arranged in the body inner region.

A body-mounted connection of the electrical line of the electromechanical wheel brake to the electronic open-loop and closed-loop control unit of the motor vehicle is arranged in a protected region of the vehicle body that is atmospherically ventilated and sealed off from the wheelhouse. This is because electrical connections are not as robust as their hydraulic counterpart. Such connections typically have cavities into which no water or no dirt may penetrate. Thus, the embodiments protect the electrical connecting device of the electrical line of an electromechanical wheel brake in the interior body region from environmental influences such as moisture, water, snow, mud and stone chips. This arrangement increases the functional reliability of the electrical line.

The electrical connecting device may be releasable. The releasable electrical connecting device is designed as a plug-in connection or a clamping connection. The releasable type of connection allows, in the event of a defect, the wheelhouse-side line is replaced and the body-side line is retained.

According to a embodiment, the first line portion is received on the body portion via a seal. The seal may be manufactured from an elastomeric material. Via the elastomeric seal, one end of the first line portion can be pushed through an opening in the body portion and connected to the second line portion via the electrical connecting device. The seal protects the electrical connecting device from water and dirt located in the wheelhouse region. The elastomeric seal also facilitates the repair of a defective cable.

According to a further embodiment, the first line portion comprises a ventilation hose which leads from an actuator of the electromechanical wheel brake to the connecting device. The ventilation hose may be arranged within a sheathing of the first line portion. The ventilation hose ends in an opening which is provided on the connecting device.

### DESCRIPTION OF THE DRAWINGS

Further embodiments emerge from the description below of an exemplary embodiment with reference to the FIGURE.

In the FIGURES:

FIG. 1 shows a detail of a motor vehicle.

### DETAILED DESCRIPTION

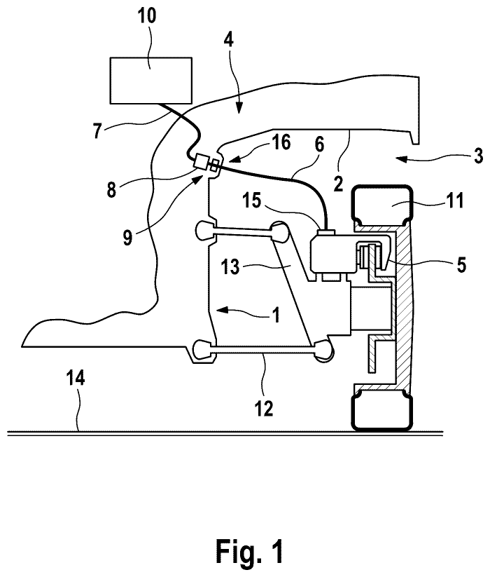

FIG. 1 shows part of a motor vehicle with a chassis 1 which, in the case of a self-supporting body, merges into a body portion 2 or, in the case of a non-self-supporting body, is connected to said body portion 2. The body portion 2 delimits a wheelhouse region 3 from a body inner region 4. A wheel 11 with an associated electromechanical wheel brake 5 is arranged in the region of the wheelhouse 3. The wheel 11 is connected to chassis 1 via a steering knuckle 13 and a wheel suspension 12 and is standing on a road 14. The body portion 2 is part of the motor vehicle body and constitutes the wheelhouse with its specially formed wall.

The electromechanical wheel brake 5 is connected via an electrical line 6 and 7 to an electronic open-loop and closed-loop control unit 10 of the motor vehicle in order to activate the wheel brake 5. The electrical line is divided into a first line portion 6 and a second line portion 7. The first line portion 6 is arranged in the wheelhouse region 3. The first line portion 6 is designed so flexibly that it resists dynamic influences (bending, rotation, kinking) originating from wheel movements. The first line portion 6 leads from a connection point 15 on the wheel brake 5 to an attachment point 16 on the body portion 2.

At the attachment point 16, an electrical connecting device 8 is provided, by means of which the first and second line portions 6 and 7 are connected to each other. As an example, the electrical connecting device 8 is arranged in the body inner region 4. That is, in a region within the vehicle that is protected from ambient influences. In addition, a seal 9 is provided at the attachment point 16, by means of which an end region of the first line portion 6 is received sealingly on the body portion 2. The second line portion 7 is arranged inside the body inner region 4. The second line portion 7 leads from the electrical connecting device 8 to the electronic open-loop and closed-loop control unit 10. Thus, the electromechanical wheel brake 5 is connected for its activation to the electronic open-loop and closed-loop control unit 10 via the releasable and dirt-protected electrical connecting device 8.

1. A motor vehicle comprising;
a chassis;
a body portion, which delimits a wheelhouse region from a body inner region;
a wheel with an associated electromechanical wheel brake is arranged on the part of the wheelhouse region
an electronic open-loop and closed-loop control unit of the motor vehicle;
an electrical line wherein the electromechanical wheel brake is connectable to the control loop via the electrical line;
a first line portion of the electrical line in the wheelhouse region
a second line portion of the electrical line in the body inner region; and
an electrical connecting device, which is arranged in the body inner region, connecting the first line portion and the second line portions to each other.

2. The motor vehicle as claimed in claim 1, wherein the electrical connecting device is releasable.

3. The motor vehicle as claimed in claim 2, wherein the releasable electrical connecting device is designed as one of a plug-in connection and a clamping connection.

4. The motor vehicle as claimed in claim 1, wherein the first line portion is received on the body portion via a seal.

5. The motor vehicle as claimed in claim 4, wherein the seal is manufactured from an elastomeric material.

6. The motor vehicle as claimed in claim 1, wherein the first line portion comprises a ventilation hose which leads from an actuator of the electromechanical wheel brake to the connecting device.

7. The motor vehicle as claimed in claim 6, wherein the ventilation hose is arranged within a sheathing of the first line portion.

8. The motor vehicle as claimed in claim 6, wherein the ventilation hose ends in an opening which is provided on the electrical connecting device.
